(19) United States
(12) Patent Application Publication
(10) Pub. No.: US 2012/0042353 A1
(43) Pub. Date: Feb. 16, 2012

(54) ACCESS CONTROL

(76) Inventor: Lauri Tarkkala, Espoo (FI)

(21) Appl. No.: 11/571,467

(22) PCT Filed: Feb. 1, 2006
(86) PCT No.: PCT/FI06/50050

§ 371 Date: Jun. 17, 2010

(30) Foreign Application Priority Data
Jan. 31, 2005 (DE) 10-2005-004-311.9

(51) Int. Cl. G06F 21/00

(52) U.S. Cl. 726/1

(57) ABSTRACT

A process and device are disclosed for depositing sequences of layers comprising a plurality of semiconductor components on a plurality of substrates (1), using a loading chamber (2) for loading a substrate carrier (1) with one or more substrates (1), a plurality of processing chambers (4.1, 4.2, 4.3, 4.4, 4.5), each comprising a gas inlet (5.1, 5.2, 5.3, 5.4, 5.5) for admitting process gases, a gas outlet (6.1, 6.2, 6.3, 6.4, 6.5), a closable loading and unloading opening (7, 8) for loading and unloading substrate carriers (3) carrying one or more substrates (1) into or out of the processing chamber (4.1), and a processing chamber heating system (8), as well as an unloading chamber (9) for unloading the substrate carrier (3) with one or more substrates (1), a conveyor (10.1, 10.2, 10.3, 10.4, 10.5 and 10.6) for conveying the substrate carrier (3) carrying one or more substrates (1) step by step from the loading chamber (2) into one of the first processing chambers (4.1, 4.2, 4.3, 4.4, 4.5), from there into a further processing chamber (4.2, 4.3, 4.4, 4.5) and then into the unloading chamber (9). In each processing chamber, a single layer is deposited and the processing chambers (4.1, 4.2, 4.3, 4.4, 4.5) are kept at the processing temperature (T) during an exchange of substrate carriers.

### FIELD OF THE INVENTION

The invention generally relates to access control. More particularly, but not exclusively, the invention relates to software based access control of different principals.

### BACKGROUND OF THE INVENTION

Present mobile devices such as mobile telephones are incorporating increasingly more sophisticated features such as music and video players and electronic book capabilities that use copyright protected content the sale of which should be protected. It is also useful to occasionally or permanently restrict access to certain features of computer-like devices in order to inhibit the spreading of computer viruses, worms and other so-called malware designed for malicious purpose.

Some operating systems have employed resource-based access control for mapping a trust level of an authenticated program or user to an access policy. It is also possible to require each application used to be reliably certified as authenticated. This enables restricting the access of each application only to given permitted resources. Such an access control mechanism may become problematic, however, if a user should be able to use arbitrary applications (possibly unauthenticated programs) to access some access-controlled resources that are yet critical for some specific operation.

For instance, users of various devices are provided with media players that should be capable of handling Digital Rights Management (DRM) protected data. In order to comply some DRM schemes, the media players should be authenticated or certified. However, authenticating every media player is costly and cumbersome, due to required recertification and signing of the media player even after every minor patch or upgrade. The certificating can be necessary to ensure that any data managed by a program is never passed to another program, device or user.

### SUMMARY OF THE INVENTION

It is an object of the invention to avoid or at least mitigate the problems of the prior art and/or to provide a new technical alternative.

According to a first aspect of the invention, there is provided, in a data processing terminal having various resources, a method for controlling access of arbitrary computer executable applications to the resources, comprising:
maintaining a set of conditional access control constraints for defining permissible combinations of the resources usable in conjunction by the applications; and
enabling running the applications only within the constraints of permissible combinations of resources used by the applications that are run in conjunction.

Advantageously, arbitrary applications can be access controlled based on the access control constraints.

The resources may be defined as usable in conjunction when the resources are usable simultaneously and/or in a sequence.

The permissible combinations may be defined indirectly by defining non-permissible combinations.

Advantageously, the defining of non-permissible combinations may enable excluding forbidden combination of resource use especially by non-certified applications that cannot be trusted to be designed to respect copyrights.

The access control constraints may define at least two mutually exclusive functional blocks or at least two mutually exclusive combinations of functional blocks.

The access control constraints may be defined by means of access control objects. Different services may be assigned with respective service identifiers, different access objects are associated with respective access logs and services call for access objects and thereby the service identifiers of calling services are respectively stored in the access logs of the called services. The access control constraints may be functions capable of each returning a single Boolean value based on one or more of the access logs.

Providing access logs with service identifiers indicative of services using given access control objects and computing Boolean values as output of access control constraints may result in computationally simple access control mechanism.

Access of the arbitrary applications to different services usable in conjunction may also be controlled by the maintained conditional access control constraints by enabling running the applications only within the constraints of permissible combinations of services used by the applications that are run in conjunction.

According to a second aspect of the invention there is provided a data processing terminal having various resources and capable of executing arbitrary computer executable applications using the resources, comprising:
a memory for maintaining a set of conditional access control constraints defining permissible combinations of the resources usable in conjunction by the applications; and
a processor configured to run the applications only within the constraints of permissible combinations of resources used by the applications that are run in conjunction.

According to a third aspect of the invention there is provided a computer program for controlling the operation in a data processing terminal having various resources in order to control access of arbitrary computer executable applications to the resources, comprising:
computer program code for causing the terminal to maintain a set of conditional access control constraints for defining permissible combinations of the resources usable in conjunction by the applications; and
computer program code for causing the terminal to enable running the applications only within the constraints of permissible combinations of resources used by the applications that are run in conjunction.

According to a fourth aspect of the invention there is provided a sub-assembly for controlling the operation in a data processing terminal having various resources in order to control access of arbitrary computer executable applications to the resources, the sub-assembly comprising:
means for causing the terminal to maintain a set of conditional access control constraints for defining permissible combinations of the resources usable in conjunction by the applications; and
means for causing the terminal to enable running the applications only within the constraints of permissible combinations of resources used by the applications that are run in conjunction.

The means for causing the terminal to maintain the set of conditional access control constraints and/or the means for causing the terminal to enable running the applications within the constraints of permissible combinations of resources may be based on any combination of the following: a chipset circuitry and computer code stored in one or more chipsets.

According to a fifth aspect of the invention there is provided a method of manufacturing and controlling a data processing terminal having various resources in order to control access of arbitrary computer executable applications to the resources, comprising:
storing in the terminal computer program code for causing the terminal to maintain a set of conditional access control constraints for defining permissible combinations of the resources usable in conjunction by the applications; and
storing in the terminal computer program code for causing the terminal to enable running the applications only within the constraints of permissible combinations of resources used by the applications that are run in conjunction.

The computer program code or software may be provided as a computer product or products carried and/or stored on a data medium or embedded in a data signal. The software may also be hosted by one or more devices in a distributed fashion.

Dependent claims and the aforementioned embodiments relate to different embodiments of the invention. The subject matter contained by the embodiments and relating to a particular aspect of the invention may be applied to other aspects of the invention mutatis mutandis.

### BRIEF DESCRIPTION OF THE DRAWINGS

Embodiments of the invention will now be described by way of example with reference to the accompanying drawings in which:

FIG. 1 shows a block diagram of a mobile station according to an embodiment of the invention;

FIG. 2 shows an illustrational system of the main components according to an embodiment of the invention; and

FIG. 3 shows a flowchart representing the operation according to an embodiment of the invention.

### DETAILED DESCRIPTION

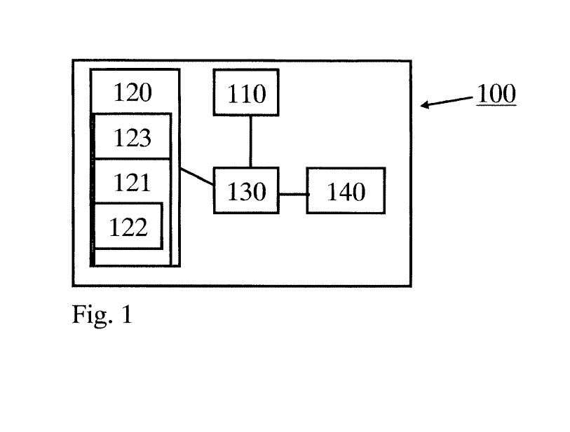

FIG. 1 shows a block diagram of a Mobile Station (MS) 100 according to an embodiment of the invention. The MS 100 includes a radio block 110, a memory 120 that includes a non-volatile memory 121 for storing long-term operating instructions 122 and a work memory 123. The MS 100 further includes a processor 130 and a user interface 140. All of these parts are connected to the processor 130. The processor is configured to read the long-term operating instructions 122 from the non-volatile memory 121 and run desired applications and services using the work memory 123. The mobile station may be, for example, a smart phone capable of running operator-specific and/or user-defined applications. The mobile station may be capable of running software that complies with open specifications. The physical structure of the mobile station 100 is not however essential as long as it allows controlling the access of some different software based elements with each other.

Particular embodiments of the invention are described in detail, including the best mode known by the inventor. These embodiments seek to restrict providing particular services when using unauthenticated or untrusted software, without requiring a comprehensive control or restriction on operations that each separate service normally performs. Some services can be prohibited even though it would consist of co-operating, but non-communicating, untrusted software. Hence, a finer level of granularity of access control should be provided than by using prior known simple barring of access to particular resources that might enable undesired services.

In describing the examples, the following assumptions are being made as follows:
1. The access control mechanism does not prohibit the termination of any process.

2. The state required per principal is constant.

3. Computationally the method is very light.

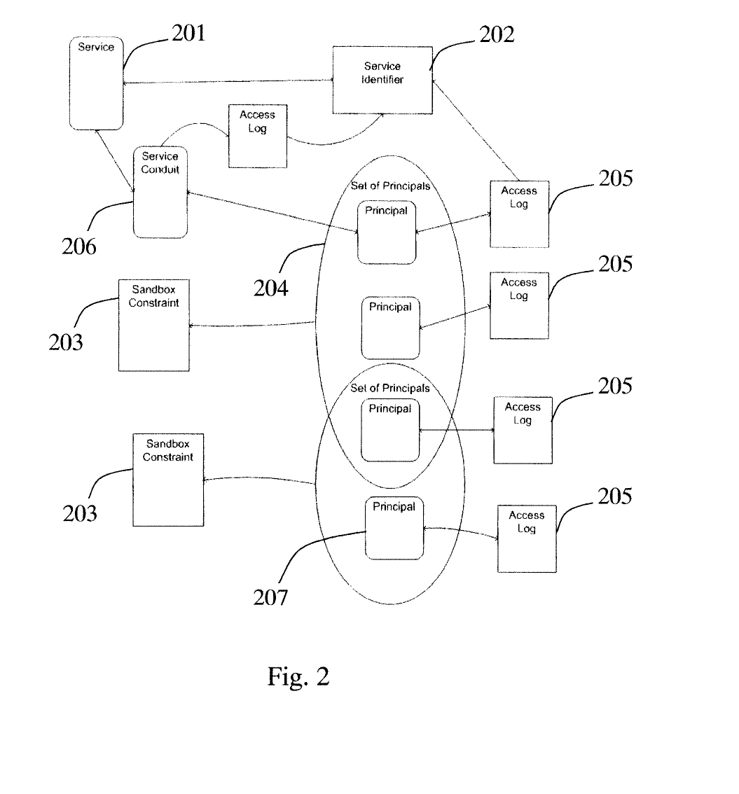

In the following, a description of a framework for the invention according to an embodiment is illustrated in FIG. 2 provided based on the notions of services 201, service identifiers 202, access control constraints 203 also referred to as sandbox constraints, sets of principals 204, access logs 205, service conduits 206 and principals 207. The purpose of the framework is to provide the ability to provide configurable constraints on the behaviour of communicating and non-communicating sets of programs.

Certain terms are next described before further description of the embodiments of the invention. These terms may best be appreciated when read with reference to FIG. 2.

A service embraces any mechanisms in an operating system that are usable to provision use of operating system features, resources or functions to a principal or service conduit. These mechanisms include operating system calls, device drivers and/or server programs.

A service identifier is an arbitrary unique name for any service. The identifier can be statically assigned or dynamically generated. The service identifiers can contain a structure or conform to a given hierarchy in order to provide uniqueness when dynamically generated. The service identifiers can be represented as arbitrary bit-vectors, for instance. A service identifier should reliably identify a service.

A resource conduit, or a service conduit, refers to any local service that is usable for transferring data or providing a service. These local services or objects can be, for example, files or programs with Inter Process Control (IPC) capability. If Symbian® Operating System (OS) is used in the MS 100, the service conduits can involve server programs. A service conduit, like a principal (described in the following), can be live or dead.

A principal refers to an object of the access controlling (that is, constraining) an application or program, for instance. A principal may be a service conduit and a service conduit may be a principal. Each principal is associated with a respective access log. A principal is live when it exists in the system and its access log is available for inspection. A dead principal has already performed its function and has been removed from the system. For a dead principal, no access log is necessarily available for inspection. There is also not necessarily any information available as to what function(s) a dead principal has performed, when and/or how. The change of a principal from a live state to a dead state is referred to as termination of a principal.

Access object is a collective term for covering both principals and service conduits by a common name.

The access log is associated by attaching, for example, to every access object. An access log lists all the service identifiers of services that have provided service or information to the access object.

Sometimes independent non-communicating principals might collectively break an access control constraint. Therefore, it is desirable to associate principals to sets of principals over which access control constraints can be computed. These sets need not be disjoint, that is, need not be having no elements in common.

A set of principals that can be computed explicitly consists of live principals. A set that consists of live principals and zero or more dead principals is referred to as a history of principals. A complete history of principals cannot necessarily be represented explicitly to avoid memory overflow. Instead, all information relevant to an access control constraint concerning a history of principals must be propagated from the dead principals to the live principals. This is feasible, given that the access control constraints are of a certain nature. For example, if the access control constraints do not care about the relationships of service identifiers within an access control log of a single principal in a history of principals then it is possible to create a single access log for all the dead principals in a history of principals and to simply copy the service identifiers from all the dead principals to this access log.

An access control constraint, that is, an access constraint, is evaluated over the access logs of principals in sets of principals or histories of principals. An access constraint is preferably a function that returns a Boolean value TRUE or FALSE. The access constraints are implemented using a logic formula, for example. An access control constraint for a set of principals should result the same value even if a member in a sets of principals is terminated. Otherwise, the access constraints might not be able to cope with sudden termination of a principal.

FIG. 2 shows an illustrational system of the main components according to an embodiment of the invention. In particular, FIG. 2 illustrates the relationship between different elements of an access constraint system. It should be appreciated that there is a distinction between computing a flow of service provisioning over a service conduit and the flow of information over a service conduit.

The direction of information flow is fast to compute based on the sender and receiver relationship that is either a simplex or duplex relationship. However, without specific knowledge of the nature of a given service, it is impossible to determine whether the sender or receiver in an information flow is providing the service. A service may be rendered with the help of a complex protocol exchange, involving multiple signals by both parties, initiated either by the provider or the consumer of that service. Without knowing the exact protocol syntax and semantics it is not feasible to compute which party is the consumer and which party is the producer of that service. Two ways to resolve this are suggested: the services are annotated (it is easy to determine or compute which party is the consumer and which party is the producer) or it is assumed that services are provided in both directions (i.e. both parties in an exchange are both consumers and producers).

Basically, the system can be described with following statements:
1. For each service identifier there is associated a set of services that are exclusively allowed to enter the service identifier into an access log.
2. If an access object accesses or uses a service then the service identifier of the service is appended to the access log of the access object.
3. If a principal uses or accesses a service conduit, then the access log of the principal is appended to the access log of the service conduit and vice versa.
4. If a service conduit accesses or uses another service conduit, then the access logs of the service conduits are appended to each other.
5. If a service identifier is about to be entered into an access log of a principal for the first time then the access control constraints are evaluated. If an access control constraint would evaluate to false after appending the service identifier, then the present operation is denied.

The evaluation of access control constraints is based on computing access control constraints for the sets of principals. This computation can be performed in a multitude of ways. For instance, the access control constraints can themselves provide sufficient expressive power and information to implicitly define these sets. Alternatively, the sets of principals can be defined via explicitly in the access control constraints using a grouping formula based on e.g. propositional logic.

In the general case, the access control constraints may be expressed using first order predicate logic with a predicate P (principal, propositional logic formula over service identifiers) defined to be the value of propositional logic formula over service identifiers when evaluated over the service identifiers in the access log of principal.

The access control constraints can be supplied in a variety of ways, for instance, by fixing the access control constraints during time of manufacture of the embodiment of this invention or by allowing on-the-fly policy updates such as so-called authenticated Over-the-Air updates of security policies. For example, the access control constraints can be supplied by authenticating access control update messages using a contemporary PKI or shared secrets and sending them over the Internet or a cellular network (such as GSM). Such authenticating access control update may involve one or more insertions of new constraints and/or removal of old ones constraints.

The evaluation of a first order predicate logic is computationally heavy (requiring exponential time using deterministic algorithms), and as such a compromise solution is advantageous and next described for computationally feasibly grouping principals and evaluating access control constraints.

The dynamic aspect of the system affects the definition of the access control constraints. It is practically unavoidable that any principal involved in the provisioning of a service may terminate immediately after it has performed its function, or even whilst it should perform its function, either intentionally or accidentally. For example, the chain of events may be such that a first principal first writes data to a first file and terminates. A second principal is subsequently started to forward that data to a second file. This clearly implies transitivity for the service identifiers in the access logs, but also less obviously has an impact on how the sets of principals may be formed.

An access control constraint should not prohibit the termination of a principal. Sometimes, a principal may suddenly terminate. This has implications for access control constraints evaluated over sets of principals, as the sets may contain more than one member element and any one of them may terminate.

Conversely, the statements that can be robustly expressed may be limited to statements that are limited to the following forms:
There should not exist a history of principals where the access logs of the live principals and the dead principals unconditionally contain a defined conjunction of service identifiers.
There should not exist a single live principal such that the access log and the principal do not satisfy a defined access control constraint expressible in propositional logic.

An example of a computationally tractable form of expressing the access control constraints is next described. Each access control constraint is split into a grouping formula and an access control formula. The purpose of the grouping formula is to compute the sets of principals over which the access control formula must hold.

The grouping formula is defined using propositional logic over a universe of the propositions available related to the attributes of principals. For example, if a scalar value denoting a trust level can be associated with each principal, a grouping formula can be given as a trust level threshold value such as value 42. A principal may have a set of static authorizations. A principal may also have an authenticated creator. Correspondingly, a grouping formula can then be stated in the form “has authorization X” and “is NOT published by Y” or even “has trust level <42”. A grouping formula can also include a proposition that limits an access control constraint to a single defined principal.

An additional access control constraint directive is_singleton is defined in an embodiment of the invention. If for an access control constraint the is_singleton directive is defined to be true then the grouping constraint produces sets of principals that contain exactly one principal that causes the grouping formula to evaluate to true. If the directive is_singleton is false then all the principals that satisfy the grouping constraint G of the access control constraint are placed into a common set of principals. This means that if is_singleton is false corresponding to a grouping constraint G then there will exist zero or one histories of principals for G at any given time. If is_singleton is true for a grouping constraint G then there may be many (or none) singleton sets of (live) principals each containing exactly one principal for G alive at any moment of time. The reason for creating a mechanic like is_singleton is to allow the use of access control formula of the form ‘IF service identified by id_x is NOT present in the access log for a principal THEN service identified by id_y is allowed for that principal’. A similar feature is implemented in an alternative embodiment of the invention by adding expressive power beyond that of normal propositional logic to the computational formula. The use of is_singleton enables using standard propositional logic. The advantage of using a separate is_singleton bit is also that it is simple to conclude how to recover from an attempted policy violation (i.e. attempted violation of an access control constraint). Let the access control constraint be denoted as <is_singleton, G, S> where G is the grouping formula and S is the access control formula. The grouping algorithm can then be denoted substantially as follows:

| | |
|---|---|
| 1. | For each access control constraint C = <is_singleton, G, S> |
| | IF is_singleton is false AND S is not expressible as a negation of a |
| | conjunction of literals (service identifiers) THEN signal error |
| | IF is_singleton is false THEN create a set of principals Set_C. |
| 2. | For each principal: P |
| | For each access control constraint C = <is_singleton, G, S> |
| | IF P satisfies G AND is_singleton is false THEN |
| | Add P to Set_C |
| | If P satisfies G and is_singleton is true THEN |
| | Create a new Singleton_C_P |

This algorithm should be run when the set of principals or access control constraints changes. Optimization can also be performed assuming that bookkeeping is taken care of. The time complexity is O(1) when adding an access control constraint, O(n) (where n is the number of access control constraints) when a principal is added and O(1) when a principal is killed.

The access control formula can be defined using propositional logic by evaluation over a union of service identifiers in the access lists. As such, an access control formula is inherently true or false for an entire set of principals.

The lifecycle of sets and histories of principals (both referred to below as mere history of principals) can be illustrated as follows:
Each history H of principals is associated with an access control constraint C=<is_singleton, G, S>. In the case that we have a history of principals, then is_singleton can be assumed to be false.
For each history H we also associate a single access log L of the ‘dead principals’. This access log L is attached to the history H for the lifetime of H. L is removed from the system only after H is removed in an embodiment of the invention. This embodiment works particularly well when the size of L is constant.
IF a principal P satisfies the grouping constraint G of an access control constraint C THEN P is added to H.
If a principal P in H is dead, then the service identifiers from the access log of P are copied to the access log L of the dead principals associated with H. All traces of P can then be erased from the system if resources need to be conserved.
IF a principal P in H access a resource that causes a new service identifier ‘x’ to be added to its access log so that ‘x’ had not been present in the access log of any principal in H before THEN the system checks that the access control formula S would be satisfied even if ‘x’ is added to the access log of P ELSE the access is denied.

It follows that the access control formula S cannot be interested in relationships of service identifiers within an access log of a single principal in a given H, but instead must be evaluated over a union of the access logs of principals in the H in question. This allows expression of meaningful constraints, whilst dead principals can be completely removed from the system thereby freeing system resources.

### Example on Symbian Operating System (OS)

The propositional logic for the clause ‘G’ in a constraint <is_singleton, G, S> is evaluated using the capability bits in Symbian OS Platsec. These bits include at least the following capabilities: NetworkServices, LocalServices, ReadUserData, WriteUserData and Location. These (and other) capability bits are described later in this text.

If is_singleton is false then a forbidden state is basically a collection of events in access logs that cannot all happen in the lifetime of a single set of principals.

The access control constraints are advantageously part of the Trusted Computing Base (TCB) known from Symbian and can only be modified, created, added or deleted by TCB enabled programs. The constraints are stored under into a secure directory such as \sys \sandboxes.

The service identifiers are typically integers for efficient processing. A table in \sys\sandboxes\identifiers defines a Secure Identifier (SID) and the capabilities required to set a service identifier in an access log. Each identifier is advantageously given a human readable name for reference with the access control formula, for example.

The following service identifications are defined:
Microphone: Denotes the use of a microphone.
Speaker: Denotes the use of a speaker.
Networking: Denotes the use of networking capabilities.
File system Write: Denotes the use of a file system for writing data.
File system Read: Denotes the use of the file system for reading data.
DRM: Denotes the reading of DRM protected data.
Non-UI (User Interface): This service identifier is set by all system functions that are not associated with UI functions.

The attributes available in the grouping formula are SID and the capabilities of programs. The attributes available in the access control formula are the capabilities and the service identifiers.

An access log in accordance with an embodiment of the invention is simply a bit vector that has one bit for each service identifier. The union of two access logs can be computed simply using a bit-wise OR operation, wherein a bitwise operation is one in which each bit is treated independently of all the other bits. Two access logs can be concatenated using a bit-wise OR operation. The Service Conduits are typically processes, services and files. An access log is associated to each process and file. For each service it is annotated whether the service is provided in the same direction as the information flow, in the reverse direction or bi-directionally with respect to the initiator/responder relationship of the communication flow.

Any file can be considered as a service conduit. If a program reads or writes to a file then the access logs of the file and the program are updated according to the annotations of the service identifiers.

It is appreciated that inter-process communications are slightly more problematic as it is not easy to deduce in a robust manner the direction in which a service is being provided, as the client-server relationship can be arbitrary. Therefore, a strict division of programs and server functions into services and service conduits is performed.
Programs and system calls that belong to a trusted computing environment AND that do not allow for the transfer of information between programs are considered services.
All other programs and system calls are considered service conduits.

For example a system call that allows setting the colour of a pixel could be used to covertly relay access to a service past the access control constraints. Generally, any covert channel between programs can be used for this purpose. If IPC is performed between a service and such a program that is not a service then a service identifier of the service in question is appended to the access log of the program.

Networking protocols can be used to communicate between principals outside of this framework even within the host operating system. The same applies to removable media or analogue channels such as from speaker to microphone or from screen to camera. This should be considered in the definition of access control constraints. This applies to any system that attempts to access control information in the presence of external communication channels (be they analogue or digital). Notice that many user interface functions can double up as an analogue I/O channel between programs.

Enforcing of access control is next described with more detail. A separate access control server is created. The access control server is capable of computing the sets of principals and evaluating the access control constraints. The access control server can be software based and provided by the processor 130. The IPC and file system infrastructure are modified to propagate and manage the access logs and query the access control server whenever a new service identifier would be added to an access log.

The services that would need modifying are part of the Trusted Computing Environment. Especially care should be taken with respect to any present covert channels. The presence of DRM support in Symbian 9 may resolve the cases where processes are not co-operating, but more advanced implementations should further consider covert channels for co-operating processes. Even if covert channels could not be completely barred, they are made relatively inefficient in an embodiment of the invention.

There are two main cases where this framework or embodiments of the invention are particularly useful for improving the state of DRM on Symbian.

First, such an access control constraint can be defined that prohibits the use of the microphone while there exists a process that has the DRM service identifier set in its access log. This substantially prohibits “re-digitizing” content using the same handset that is playing it.

Second, the following constraint can be defined: If DRM content is read by a program that does NOT have the DRM capability set, then disable the use of services that set a “non-UI” service identifier, except for the “file read” identifier. Hence, such non-certified DRM capable player programs can be run that are able to read instructions and/or commands from a file. The constraint prevents this player program from communicating information by any other means but the user interface.

In an embodiment of the invention, it can also be required that it should not be possible to have the following thee service identifiers used in the same set of principals: Microphone, Speaker and Network unless the software is trusted, that is, the software meets a predefined grouping formula negation. Various grouping formula negotiation techniques are known in the state of art. This embodiment enables prohibiting the use of VoIP services, for instance, without crippling the entire IP stack.

A framework for access controlling the behaviour of programs in an operating system such as Symbian 9 is next further described for the interest of the reader.

OS capabilities are divided into two categories, user capabilities and system capabilities. User capabilities are a small and relatively easily understandable set of capabilities which can be presented to owners of a device when they are installing applications. The user capabilities enable the users to check that the application should not perform any unexpected operations when used. System capabilities are not transparently presented to the user. Instead, the system capabilities are concealed from the users. This is because not all the implications of system capabilities are easily understood users.

Major capabilities possibly usable in different embodiments of the invention have been identified in the following list together with operations right's the access to which capabilities can control:

NetworkServices—access to remote services without any restriction on its physical location. Typically, this location is unknown to the phone user. In addition, such services may incur cost for the phone user.

LocalServices—access to remote services in the close vicinity of the phone. The location of the remote service is well-known to the phone user. In most cases, such services will not incur cost for the phone user.

ReadUserData*—read access to data confidential to the phone user. This capability supports the management of user's privacy. Contacts, messages and appointments are always seen user confidential data. For other contents such as images or sounds, it may depend.

WriteUserData*—management of the integrity of user data. Please note that this capability is not symmetric with ReadUserData. For instance, one may wish to prevent rogue applications to delete music tracks but may not wish to restrict read access to them. If it is clear that all private data are user data, but the choice of confidential data is more arbitrary and may depend of the UI implementation.

Location—access to the location of the device. This capability supports the management of user's privacy regarding the phone location.

*Notice: the capabilities ReadUserData and WriteUserData are provided to protect the user's privacy. Not all the data of a mobile phone, for example, have to be protected by these capabilities. There are a number of use cases where particular application data may be either private or public as far as the user is concerned. Still images and video footages, for instance, may be either rather neutral or very sensitive depending on their subject. Contacts, mail and calendar entries are typically personal. It is rather unimportant whether anyone sees the public data, but usually the private data should be protected from undesired access of other people and malicious software, that is, malware. The UI specification should account for these issues and provide means for protecting private data. The protection can be carried out, for example by using password protection, dividing data into different folders depending on the desired accessibility of given data (e.g. type of data), or by any combination of these.

In an embodiment of the invention, the system capabilities include one or more of the following items:

Write access to executables and shared read-only resources. Typically very critical capability as this capability grants access to executable files and therefore to their capabilities.

Direct access to communication device drivers.

Power management, that is, the right to kill any process in the system, to power off unused peripherals, to switch the machine into standby state, wake it up again or power it down completely.

Access to multimedia device drivers for multimedia devices such as sound device, camera, video device.

Read access to network operator, phone manufacturer and device confidential settings or data. For instance: the pin lock code, the list of installed applications. Settings that are not confidential such as the system time need not be protected by this capability.

Write access to settings that control the behaviour of the device. For instance, device lock settings, system time, time zone, alarms.

Access to protected content. DRM agents use this capability to decide whether an application should have access to DRM content. Applications being granted DRM are trusted to respect the rights associated with this content.

Right to create a trusted UI session, and therefore to display dialogs in a secure UI environment. Trusted UI dialogs are rare, mainly used when confidentiality and secure are critical, as with password dialogs, for instance. Normal access to the user interface and the screen does not require this capability.

Right for a server to register with a protected name. Protected names start by a “!”. The kernel will prevent servers without ProtServ capability from using such a name and therefore will prevent protected servers from being impersonated.

Access to disk administration operations that affect to more than one file system unit (file or directory) or that affect to overall file system integrity and/or behaviour, etc). For instance, right to reformat a disk partition.

Right to modify or access network protocol controls. Typically when an action can change the behaviour of all existing and future connections, it should be protected by NetworkControl. For instance, forcing all existing connections on a specific protocol to be dropped or changing the priority of a call.

Read access to entire file system.

Right to generate software key & pen events and to capture any of them regardless of the status of the application. When having the focus, normal applications will not need SwEvent to be dispatched key and pen events.

It is sometimes necessary to reliably identify an application and/or its vendor. Symbian Platform Security model allows servers to control access to their APIs without knowing their requesters and therefore avoids the need of maintaining an access control list. For occasional need to uniquely identify an application and even its source, a Secure Identifier (SID) and a Vendor Identifier (VID) are provided. The SID is an identifier that is guaranteed to be locally unique. The VID is contained by executable files in order to provide for a unique identification of the source of a given executable file. In most cases, this VID is zero, that is, the source of the executable file is not needed for any security checks.

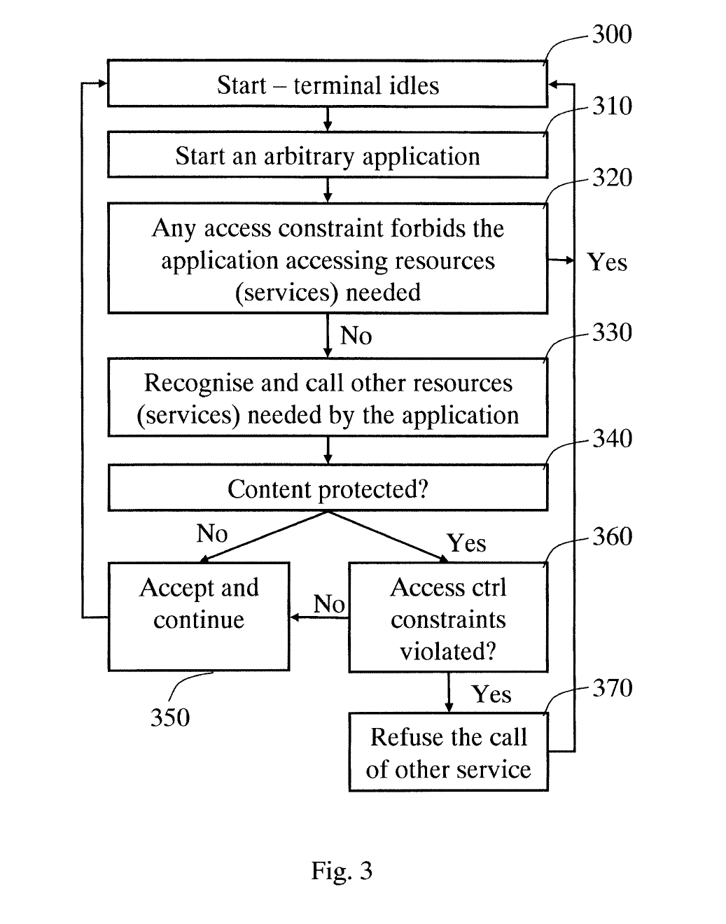

FIG. 3 shows a flowchart representing the operation according to an embodiment of the invention. The flowchart starts from step 300, in which the terminal idles. Next, in step 310, the first arbitrary application is started. This application uses one functional block of the radio block for streaming down media content. On starting the first arbitrary application, the terminal checks in step 320 that no access constraints forbid the use of the radio block by the first application. If any forbidding constraints found, the access is denied and the application may be stopped and/or the application may provide an error message, and the process resumes to step 300. Otherwise, in step 330, the terminal recognises the type of the media content to be received and starts a third-party media player, configured by the user as a preferential player for that media type. On starting the media player, the terminal checks 340 if the content is protected. If not, the execution proceeds to step 350 and the terminal allows starting of the recording, else the execution jumps to step 360. In step 360 it is checked if any access constraints are violated. Assuming none, the terminal proceeds to step 350. Then, a called service or resource starts, such as playing back the content (that is being streamed down) using the media player. If the check of step 360 results yes, the terminal prohibits 370 the recording because of a forbidden conjunction of used functions. Next, the operation resumes to step 310.

It should be noticed that in a typical multitasking environment such as that used in Nokia communicators, a number of flows illustrated in FIG. 3 can be run simultaneously.

An embodiment of the invention involves creating mutually exclusive access conditions in an access control system. The embodiment may selectively enable performing any one of plural operations alone but not in combination with another operation.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. In a data processing terminal having various resources, a method for controlling access of arbitrary computer executable applications to the resources, comprising:
maintaining a set of conditional access control constraints for defining permissible combinations of the resources usable in conjunction by the applications; and
enabling running the applications only within the constraints of permissible combinations of resources used by the applications that are run in conjunction.

2. A method according to claim 1 wherein the permissible combinations are defined indirectly by defining non-permissible combinations.

3. A method according to claim 1, wherein the access control constraints define at least two mutually exclusive functional blocks or at least two mutually exclusive combinations of functional blocks.

4. A method according to claim 1, wherein the access control constraints are defined by means of access control objects.

5. A method according to claim 4, wherein different services are assigned with respective service identifiers, different access objects are associated with respective access logs and services call for access objects and thereby the service identifiers of calling services are respectively stored in the access logs of the called services.

6. A method according to claim 5, wherein the access control constraints are defined by Boolean logic.

7. A method according to claim 1, wherein access of the arbitrary applications to different services usable in conjunction is also controlled by the maintained conditional access control constraints by enabling running the applications only within the constraints of permissible combinations of services used by the applications that are run in conjunction.

8. A data processing terminal having various resources and capable of executing arbitrary computer executable applications using the resources, comprising:
a memory;
stored in the memory, a set of conditional access control constraints defining permissible combinations of the resources usable in conjunction by the applications; and
a processor configured to run the applications only within the constraints of permissible combinations of resources used by the applications that are run in conjunction.

9. A terminal according to claim 8, wherein the permissible combinations are defined indirectly by defining non-permissible combinations.

10. A terminal according to claim 8, wherein the access control constraints define at least two mutually exclusive functional blocks or at least two mutually exclusive combinations of functional blocks.

11. A terminal according to claim 8, wherein the access control constraints are defined by means of access control objects.

12. A terminal according to claim 11, wherein different services are assigned with respective service identifiers, different access objects are associated with respective access logs and services call for access objects and thereby the service identifiers of calling services are respectively stored in the access logs of the called services.

13. A terminal according to claim 12, wherein the access control constraints are defined by Boolean logic.

14. A terminal according to claim 8, wherein access of the arbitrary applications to different services usable in conjunction is also controlled by the maintained conditional access control constraints by enabling running the applications only within the constraints of permissible combinations of services used by the applications that are run in conjunction.

15. A computer program for controlling the operation in a data processing terminal having various resources in order to control access of arbitrary computer executable applications to the resources, comprising:
computer program code for causing the terminal to maintain a set of conditional access control constraints for defining permissible combinations of the resources usable in conjunction by the applications; and
computer program code for causing the terminal to enable running the applications only within the constraints of permissible combinations of resources used by the applications that are run in conjunction.

16. A sub-assembly for controlling the operation in a data processing terminal having various resources in order to control access of arbitrary computer executable applications to the resources, the sub-assembly comprising:
means for causing the terminal to maintain a set of conditional access control constraints for defining permissible combinations of the resources usable in conjunction by the applications; and
means for causing the terminal to enable running the applications only within the constraints of permissible combinations of resources used by the applications that are run in conjunction.

17. A sub-assembly according to claim 16, wherein the means for causing the terminal to maintain the set of conditional access control constraints and/or the means for causing the terminal to enable running the applications within the constraints of permissible combinations of resources are based on any combination of the following: a chipset circuitry and computer code stored in one or more chipsets.

18. A method of manufacturing a data processing terminal having various resources and capable of controlling access of arbitrary computer executable applications to the resources, comprising:
storing in the terminal computer program code for causing the terminal to maintain a set of conditional access control constraints for defining permissible combinations of the resources usable in conjunction by the applications; and
storing in the terminal computer program code for causing the terminal to enable running the applications only within the constraints of permissible combinations of resources used by the applications that are run in conjunction.
